(19) United States
(12) Patent Application Publication
(10) Pub. No.: US 2026/0003131 A1
(43) Pub. Date: Jan. 1, 2026

(54) OPTICAL CONNECTION ASSEMBLY

(71) Applicant: Fujikura Ltd., Tokyo (JP)

(72) Inventors: Tomoyuki Shinoda, Sakura-shi (JP); Toshiaki Nakajima, Sakura-shi (JP); Hiroyuki Takamizawa, Sakura-shi (JP); Hidetoshi Katahira, Sakura-shi (JP)

(73) Assignee: Fujikura Ltd., Tokyo (JP)

(21) Appl. No.: 18/877,858

(22) PCT Filed: Feb. 13, 2023
(86) PCT No.: PCT/JP2023/004723

§ 371 Date: Dec. 20, 2024

(30) Foreign Application Priority Data
Jun. 24, 2022 (JP) 2022-101616

(51) Int. Cl. G02B 6/38; G02B 6/44

(52) U.S. Cl. CPC G02B 6/3825; G02B 6/4471

(57) ABSTRACT

An optical connection assembly (into which a plurality of optical connectors are inserted) includes: a plurality of adapter modules that include a plurality of holding portions, include an insertion hole into which the optical connector is insertable and in which the inserted optical connector is holdable (the plurality of holding portions are disposed in parallel in a first direction intersecting an insertion direction in which the optical connector is inserted); and a shaft member that extends in a second direction intersecting the first direction and the insertion direction and supports the plurality of adapter modules. The plurality of adapter modules are relatively movable along the shaft member in the second direction. A distance over which the plurality of adapter modules are relatively movable is equal to or greater than a dimension of the insertion hole in the second direction.

This is a national phase of International Patent Application No. PCT/JP2023/004723, filed on Feb. 13, 2023, which claims priority to Japanese Patent Application No. 2022-101616, filed Jun. 24, 2022. The content these applications are is incorporated herein by reference.

### Technical Field

The present invention relates to an optical connection assembly.

### Background

For construction of an optical network, a cabinet that accommodates optical fiber wiring has been in widespread use. In such a cabinet, when a density of the optical fiber wiring increases, accessibility to optical fibers accommodated in the cabinet may be reduced.

In order to improve accessibility to the optical fibers, for example, a cabinet as disclosed in Patent Document 1 is used. The cabinet includes a housing and a plurality of trays that are configured to be drawn out from the housing. Optical fiber wiring is bundled in predetermined units each of which is accommodated in the trays. An operator can perform wiring work of the optical fibers, such as insertion and removal of an optical connector, by drawing out the tray from the housing.

### CITATION LIST

Patent Document 1: U.S. Pat. No. 9,720,196

In the cabinet as disclosed in Patent Document 1, when the operator accesses the optical connector and performs the wiring work, a space for drawing out the tray from the housing is required. Providing such a space is a problem in that a wiring density of the optical fibers is increased in a building (data center or the like).

### SUMMARY

One or more embodiments of the present invention provide an optical connection assembly capable of further increasing a wiring density of optical fibers.

An optical connection assembly according to one or more embodiments of the present invention is an optical connection assembly into which a plurality of optical connectors are inserted, the optical connection assembly including: a plurality of adapter modules which include a plurality of holding portions, which include an insertion hole into which the optical connector is insertable and in which the inserted optical connector is holdable, and in which the plurality of holding portions are disposed in parallel in a first direction intersecting an insertion direction in which the optical connector is inserted; and a shaft member configured to extend in a second direction intersecting the first direction and the insertion direction and support the plurality of adapter modules, in which the plurality of adapter modules are relatively movable along the shaft member in the second direction, and a distance over which the plurality of adapter modules are relatively movable is equal to or greater than a dimension of the insertion hole in the second direction.

In addition, in an optical connection assembly according to one or more embodiments of the present invention, the first direction may be a gravity direction, and the shaft member may support an upper end portion of the adapter module.

In addition, in an optical connection assembly according to one or more embodiments of the present invention, the adapter module may include a restriction member, and the restriction member may be switchable between a restriction state in which the relative movement of the adapter module with respect to the shaft member is restricted and an allowance state in which the relative movement of the adapter module with respect to the shaft member is allowed by moving in the insertion direction.

In addition, in an optical connection assembly according to one or more embodiments of the present invention, the restriction member may have an inserting hole through which the shaft member is inserted and which is elastically expandable and contractible, the inserting hole may include a small diameter portion in which a first virtual circle is inscribed when viewed from the second direction and a large diameter portion in which a second virtual circle is inscribed when viewed from the second direction and which communicates with the small diameter portion in the insertion direction, and in a case in which a diameter of the first virtual circle is denoted as Φ1, a diameter of the second virtual circle is denoted as Φ2, and a diameter of the shaft member is denoted as Φ3, a relationship Φ1<Φ3<Φ2 may be established.

In addition, in an optical connection assembly according to one or more embodiments of the present invention, the number of optical fibers that are insertable from one direction per adapter module may be thirty or more.

In addition, in an optical connection assembly according to one or more embodiments of the present invention, a maximum value of the dimension of the insertion hole in the second direction may be in a range of 10 to 12 mm.

In addition, in an optical connection assembly according to one or more embodiments of the present invention, the distance over which the adapter module is relatively movable in the second direction may be 20 mm or more.

According to one or more embodiments of the present invention, it is possible to provide an optical connection assembly capable of further increasing a wiring density of optical fibers.

### BRIEF DESCRIPTION OF DRAWINGS

FIG. 1 A perspective view showing an optical fiber cabinet according to one or more embodiments.

FIG. 2 A perspective view showing an optical connection assembly according to one or more embodiments.

FIG. 3 An exploded view showing the optical connection assembly according to one or more embodiments.

FIG. 4 An exploded view showing an adapter module according to one or more embodiments.

FIG. 5 A sectional view taken along line V-V shown in FIG. 4, showing a state in which a connector is inserted into a holding portion.

FIG. 6 A view of the holding portion shown in FIG. 4 as viewed from an arrow VI.

FIG. 7 A view showing a restriction member according to one or more embodiments.

FIG. 8A A view showing a state in which the restriction member according to one or more embodiments is in a restriction state.

FIG. 8B A view showing a state in which the restriction member according to one or more embodiments is in an allowance state.

FIG. 9 A view of the optical connection assembly shown in FIG. 2 as viewed from an arrow IX.

FIG. 10 A view showing a restriction member according to one or more embodiments.

FIG. 11A A view showing a state in which a restriction member according to one or more embodiments is in the allowance state.

FIG. 11B A view showing a state in which the restriction member according to one or more embodiments is in the restriction state.

### DETAILED DESCRIPTION

Hereinafter, an optical connection assembly 1 and a cabinet 100 using the optical connection assembly 1 according to one or more embodiments will be described with reference to the accompanying drawings.

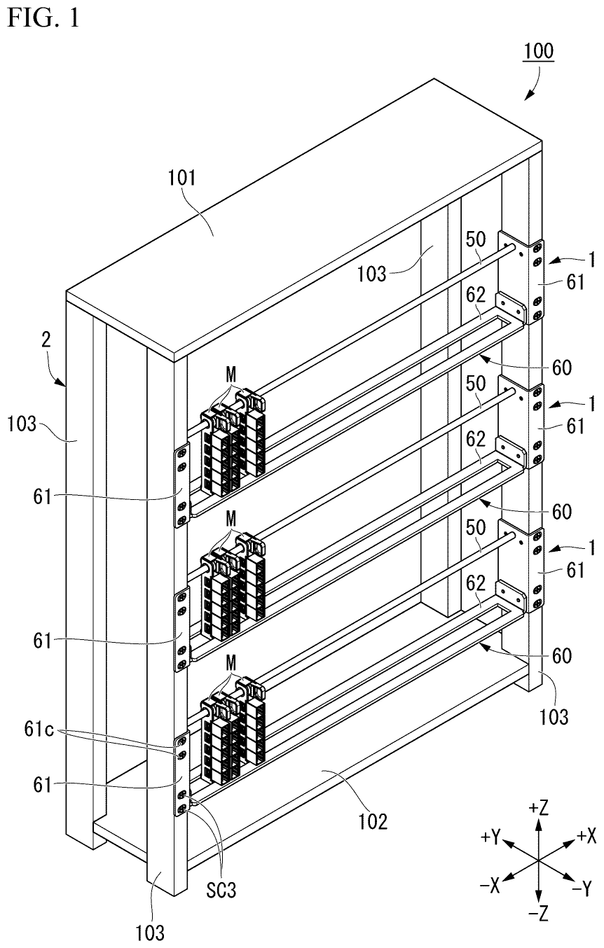

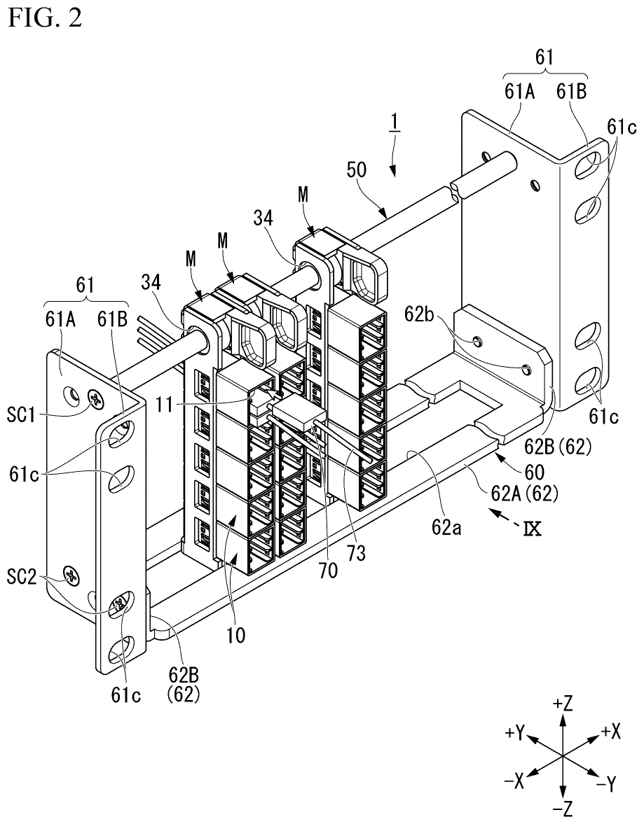

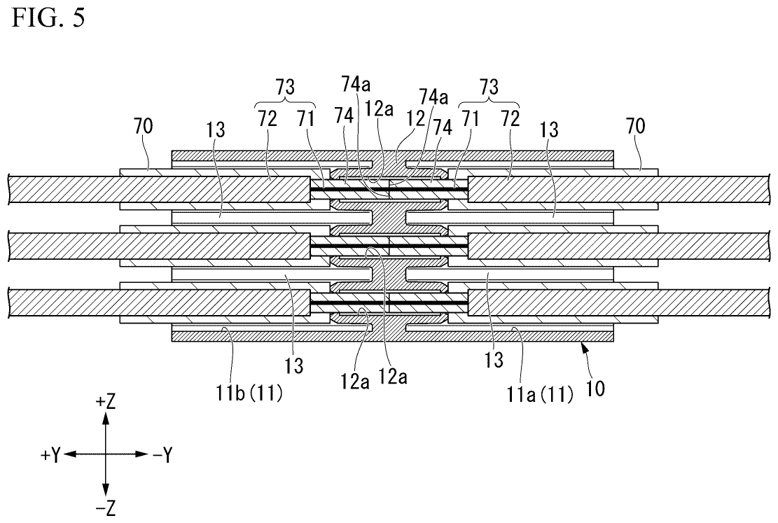

As shown in FIG. 1, the cabinet 100 according to one or more embodiments includes a housing 2 and a plurality of the optical connection assemblies 1. As shown in FIG. 2, a plurality of optical connectors 70 are inserted into each optical connection assembly 1. As shown in FIG. 5, each optical connector 70 includes an optical fiber 71. The cabinet 100 is installed, for example, in a data center or the like, and is used to manage wiring of optical fibers.

As shown in FIG. 1, the housing 2 according to one or more embodiments includes a top plate 101, a bottom plate 102, and four posts 103. Each of the top plate 101 and the bottom plate 102 has a rectangular plate shape and is disposed at an interval from each other. The four posts 103 connect corner portions of the top plate 101 and the bottom plate 102 to each other. Each optical connection assembly 1 according to one or more embodiments includes a plurality of adapter modules M, a shaft member 50, and a frame portion 60. The frame portion 60 includes a pair of side plates 61 and a bottom plate 62 connecting the side plates 61. The bottom plate 62 extends to connect two adjacent posts 103. Each of the pair of side plates 61 positioned at both ends of the bottom plate 62 is fixed to the two posts 103, whereby each optical connection assembly 1 is fixed to the housing 2. The plurality of optical connection assemblies 1 are disposed at intervals in the longitudinal direction of the post 103.

As shown in FIG. 2, in one or more embodiments, each of both end portions of the shaft member 50 is fixed to the pair of side plates 61, and the shaft member 50 extends to connect the pair of side plates 61. As a result, the shaft member 50 is bridged to the housing 2 within the cabinet 100 (see FIG. 1). The shaft member 50 supports the plurality of adapter modules M. As shown in FIG. 2, each adapter module M includes a plurality of holding portions 10. In each adapter module M, the plurality of holding portions 10 are arranged in one direction.

### Definition of Direction

As shown in FIG. 2, the optical connector 70 is inserted into the holding portion 10 of the optical connection assembly 1. In the present specification, the insertion direction in which the optical connector 70 is inserted into the holding portion 10 is referred to as a front-rear direction Y (direction along a Y-axis in FIG. 2). The optical connector 70 is inserted into the optical connection assembly 1 from both a +Y side and a-Y side. The-Y side is referred to as the front or the near side, and the +Y side is referred to as the rear or the far side. In addition, the direction in which the plurality of holding portions 10 are arranged in each adapter module M is referred to as a first direction Z. In addition, the direction in which the shaft member 50 extends is referred to as a second direction X. In one or more embodiments, the second direction X is orthogonal to the first direction Z. In addition, the front-rear direction Y, which is the insertion direction, is orthogonal to both the second direction X and the first direction Z. In one or more embodiments, the first direction Z substantially matches the gravity direction (vertical direction). The term “substantially matching” also includes a case where the first direction Z and the gravity direction can be regarded as matching when a manufacturing error, the inclination of the placement surface on which the cabinet 100 is placed, or the like is ignored. Hereinafter, the above in the gravity direction (first direction Z) is simply referred to as the above and is represented by the orientation of +Z in each drawing. The below in the gravity direction (first direction Z) is simply referred to as the below and is represented by the orientation of −Z in each drawing. In addition, one orientation in the second direction X is referred to as the right, and is represented by the orientation of +X in each drawing. An orientation opposite to the right is referred to as the left, and is represented by the orientation of −X in each drawing.

As shown in FIG. 2, each optical connector 70 is provided at an end portion of a cable 73. As shown in FIG. 5, the cable 73 includes two optical fibers 71 (only one is shown in FIG. 5) and a coating 72 that coats the two optical fibers 71. That is, each optical connector 70 includes the two optical fibers 71. Therefore, in one or more embodiments, a total of twelve optical fibers 71, that is, six optical fibers 71 from the front and six optical fibers 71 from the rear, are inserted into one holding portion 10. In addition, in the examples of FIG. 2 and the like, since each adapter module M includes five holding portions 10, thirty optical fibers 71 are inserted into one adapter module M from the front (one direction). Thirty optical fibers 71 are also inserted into the adapter module M from the rear. That is, a total of sixty optical fibers 71 are inserted into one adapter module M.

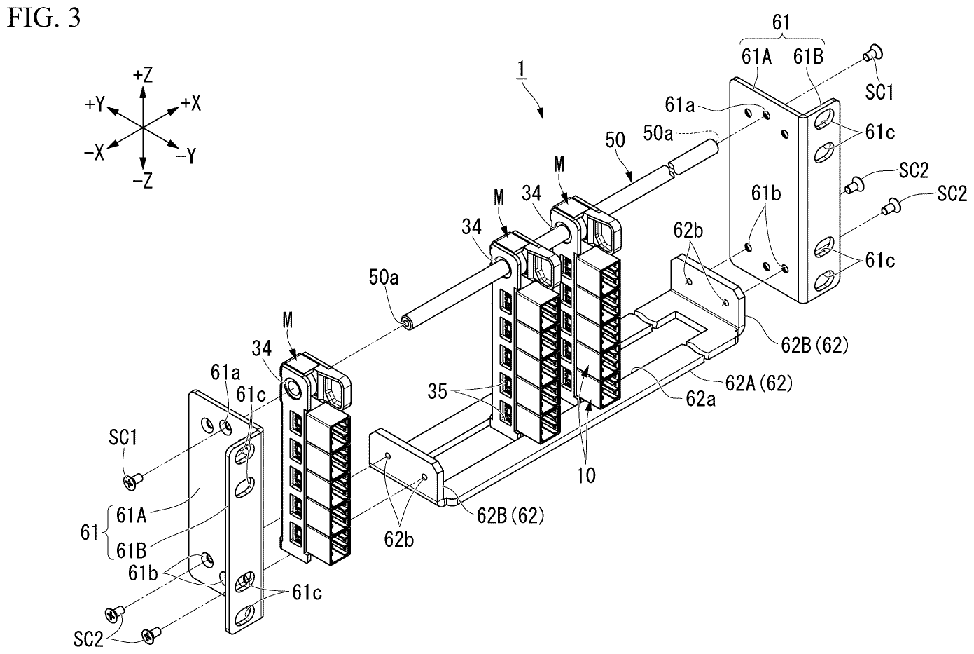

As shown in FIGS. 2 and 3, each side plate 61 includes a facing portion 61A and an attachment portion 61B. The facing portion 61A has a rectangular plate shape extending in the front-rear direction Y and in the first direction Z. As shown in FIG. 3, one screw hole 61a is formed in the upper end portion of the facing portion 61A according to one or more embodiments. In addition, two screw holes 61b disposed at an interval in the front-rear direction Y are formed in the lower end portion of the facing portion 61A.

As shown in FIGS. 2 and 3, the attachment portion 61B has a rectangular plate shape extending in the second direction X and in the first direction Z. The attachment portion 61B extends outward in the second direction X from the front end of the facing portion 61A. That is, each side plate 61 has an L-shape when viewed from the first direction Z. A plurality of screw holes 61c are formed in the attachment portion 61B according to one or more embodiments. In one or more embodiments, the attachment portion 61B is fixed to the post 103 by each screw hole 61c and the screw holes (not shown) formed on the front surface of the post 103 being fastened together by a screw SC3 (see FIG. 1).

As shown in FIGS. 2 and 3, the bottom plate 62 includes an extending portion 62A and a pair of attachment portions 62B. The extending portion 62A has a rectangular plate shape extending in the second direction X and in the front-rear direction Y. Each attachment portion 62B has a rectangular plate shape extending in the front-rear direction Y and in the first direction Z. The pair of attachment portions 62B are erected at both end portions of the extending portion 62A in the second direction X. Two screw holes 62b disposed at an interval in the front-rear direction Y are formed in the attachment portion 62B. As shown in FIG. 3, in one or more embodiments, the screw hole 61b formed in the facing portion 61A and the screw hole 62b formed in the attachment portion 62B are fastened together by a screw SC2, whereby the side plate 61 and the bottom plate 62 are connected.

As shown in FIGS. 2 and 3, a sliding hole 62a extending in the second direction X is formed at a central portion of the extending portion 62A of the bottom plate 62 according to one or more embodiments in the front-rear direction Y. The lower end portion of the adapter module M (base member 30) is inserted into the sliding hole 62a. The lower end portion of the adapter module M is fitted to the sliding hole 62a with a minute gap. As a result, the sliding hole 62a can prevent the rotation of the adapter module M around the shaft member 50 while allowing the movement of the adapter module M in the second direction X. In the shown example, the sliding hole 62a penetrates the extending portion 62A in the first direction Z, but the sliding hole 62a need not penetrate the extending portion 62A. The sliding hole 62a may be a recess that opens on the upper surface of the extending portion 62A. Alternatively, the sliding hole 62a need not be formed in the extending portion 62A.

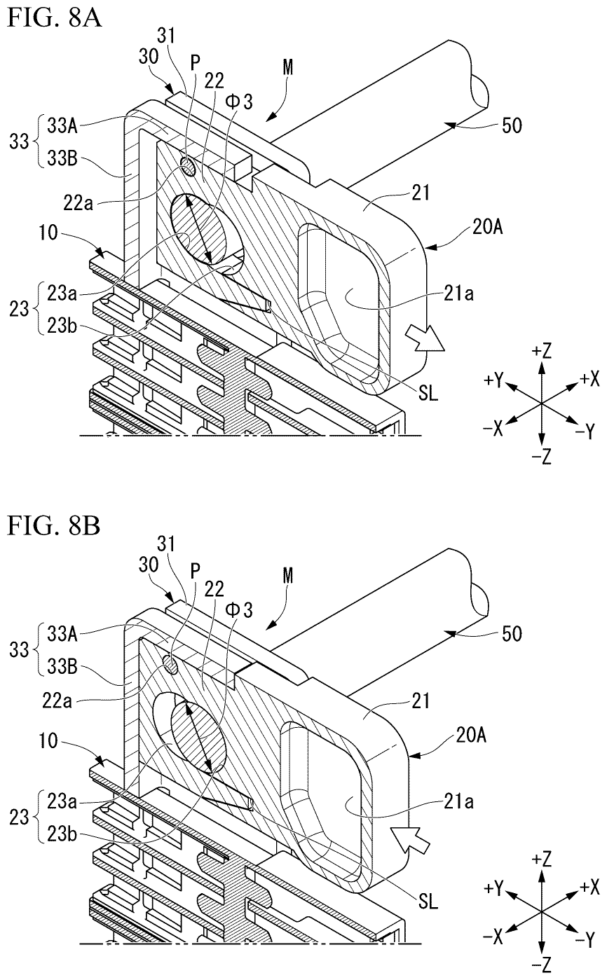

As shown in FIGS. 3 and 8A, the shaft member 50 according to one or more embodiments has a substantially circular shape when viewed in a cross section perpendicular to the second direction X. In the present specification, the term “substantially circular shape” also includes a case where the shape can be regarded as circular by ignoring any manufacturing errors. As shown in FIG. 3, a screw hole 50a is formed in each of both end portions of the shaft member 50 according to one or more embodiments. In one or more embodiments, the screw hole 61a formed in the side plate 61 and the screw hole 50a formed in the shaft member 50 are fastened together by a screw SC1, whereby the shaft member 50 is fixed to the facing portion 61A.

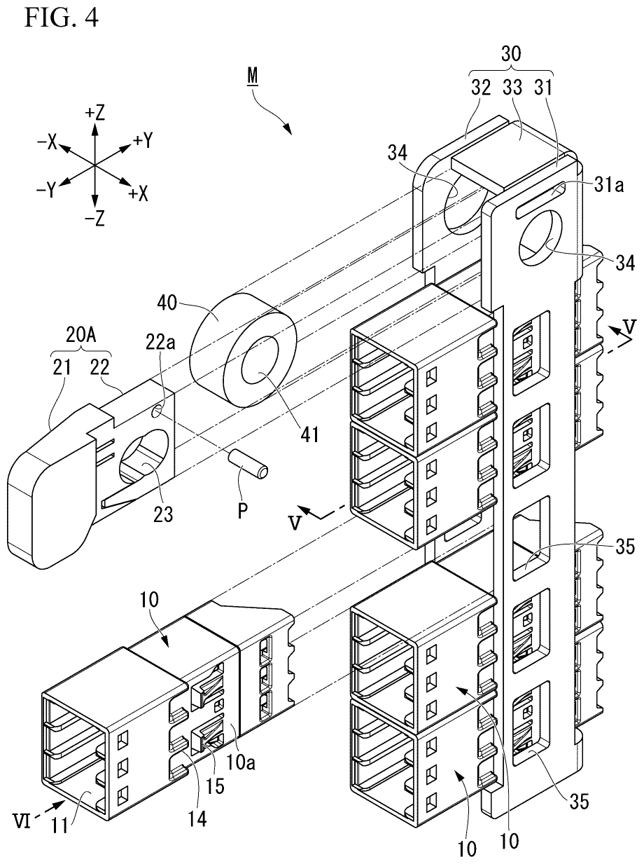

As shown in FIG. 4, the adapter module M according to one or more embodiments includes the base member 30, the plurality of (five in the shown example) holding portions 10, a restriction member 20A, and a spacer 40. As shown in FIGS. 2 and 3, the shaft member 50 penetrates the upper end portion of the adapter module M. As a result, the shaft member 50 supports the upper end portion of the adapter module M.

As shown in FIG. 4, the base member 30 according to one or more embodiments includes a first base portion 31, a second base portion 32, and a connection portion 33. Each of the base portions 31 and 32 is a plate-shaped portion extending in the front-rear direction Y and in the first direction Z. The first base portion 31 and the second base portion 32 are disposed at an interval in the second direction X. The connection portion 33 is positioned between the first base portion 31 and the second base portion 32 in the second direction X, and connects the first base portion 31 and the second base portion 32. As shown in FIG. 8A, the connection portion 33 according to one or more embodiments has an L-shape when viewed from the second direction X. More specifically, the connection portion 33 according to one or more embodiments includes a first portion 33A that extends along the upper surface of each of the base portions 31 and 32, and a second portion 33B that extends along the rear surface of each of the base portions 31 and 32. A lower end of the second portion 33B is positioned above the uppermost holding portion 10 among the plurality of holding portions 10. As a result, structural interference between the optical connector 70 (details will be described below) to be inserted into the holding portion 10 and the base member 30 is prevented.

As shown in FIG. 4, a through-hole 34 that penetrates the base portions 31 and 32 in the second direction X is formed in the upper end portion of each of the base portions 31 and 32. The shaft member 50 is inserted through the through-hole 34. The shape of the through-hole 34 is substantially circular when viewed from the second direction X and corresponds to the cross-sectional shape of the shaft member 50. In addition, an elongated hole 31a, where the dimension in the front-rear direction Y is larger than the dimension in the first direction Z is provided in the first base portion 31. The elongated hole 31a penetrates the first base portion 31 in the second direction X. The elongated hole 31a according to one or more embodiments is positioned above the through-hole 34 formed in the first base portion 31. In addition, a plurality of (five in the shown example) engagement holes 35 are formed in each of the base portions 31 and 32. Each engagement hole 35 penetrates the base portions 31 and 32 in the second direction X. The plurality of engagement holes 35 are disposed at intervals in the first direction Z. In one or more embodiments, a shape of each engagement hole 35 is rectangular when viewed from the second direction X.

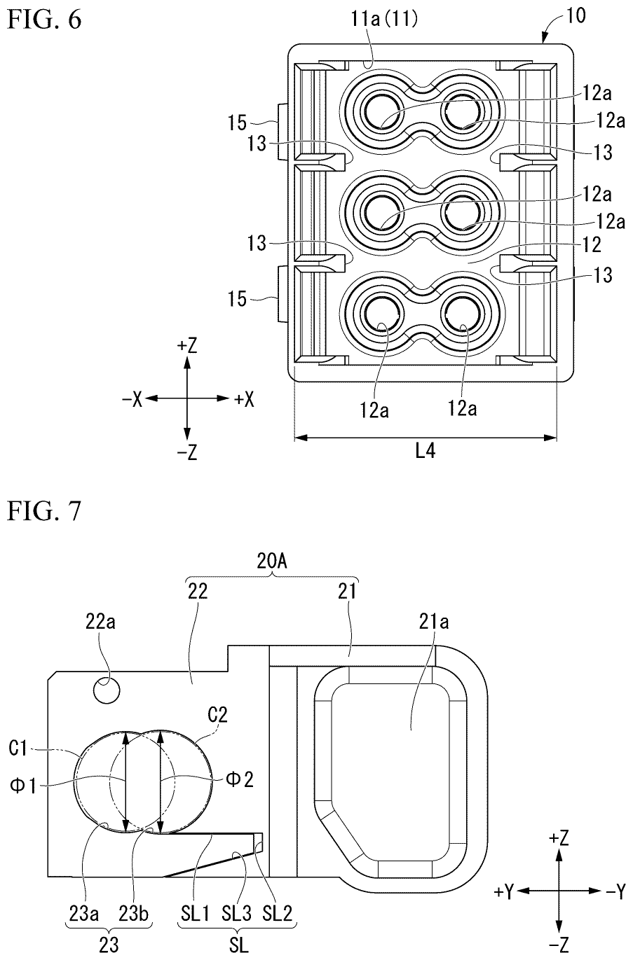

As shown in FIGS. 4 and 6, the holding portion 10 of the adapter module M has a rectangular outer shape when viewed in a cross section (X-Z plane) perpendicular to the front-rear direction Y. In a state in which the adapter module M is assembled, a part of the holding portion 10 is inserted into the inside of the base member 30. A portion of the holding portion 10 that is inserted into the inside the base member 30 and that faces the first base portion 31 or the second base portion 32 is referred to as a facing surface 10a (see FIG. 4). Although the details are not shown, the holding portion 10 includes two facing surfaces 10a. The holding portion 10 includes an insertion hole 11, a raised portion 14, and an engagement claw 15. The engagement claw 15 protrudes outward in the second direction X from the two facing surfaces 10a of the holding portion 10. Two engagement claws 15 are provided on each of the two facing surfaces 10a of the holding portion 10. Each engagement claw 15 is configured to bend inward in the second direction X. Each engagement claw 15 is positioned at the central portion of the holding portion 10 in the front-rear direction Y. The raised portion 14 is formed in a portion of the holding portion 10 that is positioned on the near side (−Y side) with respect to the engagement claw 15. The raised portion 14 is raised outward in the second direction X from the facing surface 10a.

When fixing the holding portion 10 to the base member 30, the operator adjusts the position of the holding portion 10 in the first direction Z so that the positions of the engagement claw 15 and the engagement hole 35 are aligned with each other in the first direction Z, and inserts the holding portion 10 between the first base portion 31 and the second base portion 32. As a result, the holding portion 10 is sandwiched between the first base portion 31 and the second base portion 32.

More specifically, when the engagement claw 15 comes into contact with the base portions 31 and 32, the engagement claw 15 bends inward in the second direction X. When the operator further inserts the holding portion 10, the engagement claw 15 reaches the engagement hole 35. As bending of the engagement claw 15 is released, the engagement claw 15 is inserted into the engagement hole 35. As a result, the front end portions of the base portions 31 and 32 are sandwiched between the raised portion 14 and the engagement claws 15 in the front-rear direction Y, and the holding portion 10 is fixed to the base member 30.

As shown in FIG. 5, the insertion hole 11 into which the plurality of (six in the shown example) optical connectors 70 are inserted is formed in each holding portion 10. The insertion hole 11 includes a front insertion hole 11a that opens on the front surface of the holding portion 10, and a rear insertion hole 11b that opens on the rear surface of the holding portion 10. In the shown example, three optical connectors 70 are inserted into the front insertion hole 11a, and three optical connectors 70 are inserted into the rear insertion hole 11b. The front insertion hole 11a and the rear insertion hole 11b are partitioned by a partition portion 12. As shown in FIG. 6, a plurality of (six in the shown example) inserting holes 12a are formed in the partition portion 12. As shown in FIG. 5, the inserting hole 12a penetrates the partition portion 12 in the front-rear direction Y. In addition, as shown in FIG. 6, four guide protrusions 13 that protrude inward in the second direction X are provided on both side surfaces of the front insertion hole 11a. The guide protrusions 13 have a role of guiding the position of each of the three optical connectors 70 to be inserted into the front insertion hole 11a in the first direction Z. Although the details are not shown, the same guide protrusions 13 are also provided in the rear insertion hole 11b.

As shown in FIG. 5, the optical connector 70 includes two ferrules 74 (only one is shown in FIG. 5). The two ferrules 74 are disposed at an interval in the second direction X. Each ferrule 74 holds one optical fiber 71. Each ferrule 74 includes a connection end surface 74a where the distal end of the optical fiber 71 is positioned. When each optical connector 70 is inserted into the insertion holes 11a and 11b, the ferrules 74 included in each optical connector 70 are inserted one by one into the inserting hole 12a formed in the partition portion 12. In the inserting hole 12a, the connection end surfaces 74a of the two ferrules 74 come into contact with each other. As a result, the optical fiber 71 included in the optical connector 70 inserted into the front insertion hole 11a and the optical fiber 71 included in the optical connector 70 inserted into the rear insertion hole 11b are connected.

As shown in FIG. 4, the restriction member 20A and the spacer 40 are disposed between the first base portion 31 and the second base portion 32. More specifically, the restriction member 20A and the spacer 40 are inserted into the upper end portion of the base member 30 such that the restriction member 20A faces the first base portion 31 and the spacer 40 faces the second base portion 32. An inserting hole 23 that penetrates the restriction member 20A in the second direction X is formed in the restriction member 20A. Similarly, an inserting hole 41 that penetrates the spacer 40 in the second direction X is provided in the spacer 40. The shaft member 50 is inserted through the inserting holes 23 and 41. That is, the shaft member 50 according to one or more embodiments supports the upper end portion of the adapter module M by being inserted through the through-hole 34 formed in the base member 30, the inserting hole 23 formed in the restriction member 20A, and the inserting hole 41 formed in the spacer 40.

The spacer 40 according to one or more embodiments has a circular outer shape when viewed from the second direction X. The spacer 40 can prevent the relative movement of the restriction member 20A with respect to the base member 30 in the second direction X.

As shown in FIGS. 4 and 7, the restriction member 20A includes a grip portion 21, a restriction portion 22, and the inserting hole 23. In one or more embodiments, the grip portion 21 and the restriction portion 22 are integrally formed of the same material. The restriction portion 22 is a portion where the inserting hole 23 described above is formed.

The grip portion 21 is a portion connected to the front end of the restriction portion 22. As shown in FIGS. 7 and 8A, a recess portion 21a that is recessed from the left surface of the grip portion 21 toward the right is provided in the grip portion 21 according to one or more embodiments.

As shown in FIGS. 4 and 7, a pin hole 22a that penetrates the restriction portion 22 in the second direction X is formed in the restriction portion 22. In one or more embodiments, the pin hole 22a is positioned above the inserting hole 23. As shown in FIG. 4, a pin P is inserted into the pin hole 22a. The pin P is fixed in the pin hole 22a such that the pin P protrudes from the right surface of the restriction portion 22 towards the right. In a state in which the restriction member 20A is inserted into the base member 30, the pin P protruding from the right surface of the restriction portion 22 is disposed in the elongated hole 31a of the first base portion 31. The pin P may be, for example, a spring pin that has a columnar shape and that is elastically expandable and contractible in the radial direction. In this case, work of inserting the pin P into the pin hole 22a and fixing the pin P in the restriction portion 22 can be easily performed. The pin P and the elongated hole 31a prevent the restriction member 20A from falling from the base member 30 before the shaft member 50 is inserted through the adapter module M. In addition, since the elongated hole 31a extends in the front-rear direction Y, structural interference between the pin P and the first base portion 31 is prevented when the restriction member 20A moves forward and rearward in the front-rear direction Y (details will be described below).

As shown in FIG. 7, the inserting hole 23 according to one or more embodiments has a shape in which two circles with different diameters and positions in the front-rear direction Y are combined (that is, a snowman shape) when viewed from the second direction X. More specifically, the inserting hole 23 according to one or more embodiments includes a small diameter portion 23a in which a first virtual circle C1 is inscribed when viewed from the second direction X, and a large diameter portion 23b in which a second virtual circle C2 is inscribed when viewed from the second direction X. In a case in which an outer shape of the first virtual circle C1 is denoted as Φ1 and an outer shape of the second virtual circle C2 is denoted as Φ2, a relationship Φ1<Φ2 is established. In addition, the position of the center of the first virtual circle C1 and the position of the center of the second virtual circle C2 are different from each other in the front-rear direction Y. The small diameter portion 23a and the large diameter portion 23b communicate with each other in the front-rear direction Y. In the shown example, the small diameter portion 23a is positioned on the far side (+Y side) of the large diameter portion 23b, but the small diameter portion 23a may be positioned on the near side (−Y side) of the large diameter portion 23b.

In addition, in the restriction portion 22 according to one or more embodiments, a slit SL that opens to the inserting hole 23 and that extends to the lower surface of the restriction portion 22 is formed. In the example shown in FIG. 7, the slit SL includes a first slit SL1, a second slit SL2, and a third slit SL3. The first slit SL1 extends forward (to the-Y side) from the lower end of the large diameter portion 23b. The second slit SL2 extends downward from the front end of the first slit SL1. The third slit SL3 extends from the lower end of the second slit SL2 to the lower surface of the restriction portion 22 and is inclined gradually downward toward the rear (+Y side). In addition, the width of the second slit SL2 is greater than the width of the first slit SL1 and the width of the third slit SL3.

The restriction portion 22 is configured to be elastically deformed by the formation of the above-described slit SL in the restriction portion 22. As a result, the diameter of the inserting hole 23 is configured to be elastically expanded and contracted in a range in which the restriction portion 22 can be elastically deformed. The inserting hole 23 can be elastically expanded and contracted, so that, for example, when the operator grips the grip portion 21 and moves the restriction member 20A forward and rearward in the front-rear direction Y, the hole through which the shaft member 50 is inserted can be switched between the small diameter portion 23a and the large diameter portion 23b. That is, the restriction member 20A according to one or more embodiments is configured to be switched between a state in which the shaft member 50 is inserted through the small diameter portion 23a (see

FIG. 8A) and a state in which the shaft member 50 is inserted through the large diameter portion 23b (see FIG. 8B). The configuration of the slit SL is not limited to the example shown in FIG. 7, and the configuration can be changed as appropriate as long as the inserting hole 23 can be elastically expanded and contracted. Alternatively, when the restriction portion 22 is formed of an elastically deformable material, the slit SL does not need to be formed in the restriction portion 22.

Here, when the diameter (outer diameter) of the shaft member 50 is denoted as Ø3, a relationship Φ1<Φ3<Φ2 is established in one or more embodiments. Since the relationship Φ1<Φ3 is established, in the state shown in FIG. 8A in which the shaft member 50 is inserted through the small diameter portion 23a, the shaft member 50 is fixed in the small diameter portion 23a, and the restriction member 20A is fixed to the shaft member 50. As a result, the restriction member 20A restricts the relative movement of the adapter module M with respect to the shaft member 50 in the second direction X. Meanwhile, since the relationship Φ3<Φ2 is established, a gap is generated between the shaft member 50 and the large diameter portion 23b in the state shown in FIG. 8B where the shaft member 50 is inserted through the large diameter portion 23b. Therefore, in this state, the restriction member 20A allows the relative movement of the adapter module M with respect to the shaft member 50 in the second direction X. That is, the restriction member 20A is configured to be switched between a restriction state in which the relative movement of the adapter module M in the longitudinal direction (second direction X) of the shaft member 50 is restricted and the allowance state in which the relative movement of the adapter module M in the longitudinal direction (second direction X) of the shaft member 50 is allowed by moving in the front-rear direction Y. The operator can switch between the restriction state and the allowance state, for example, by gripping the grip portion 21 and moving the restriction member 20A forward and rearward in the front-rear direction Y.

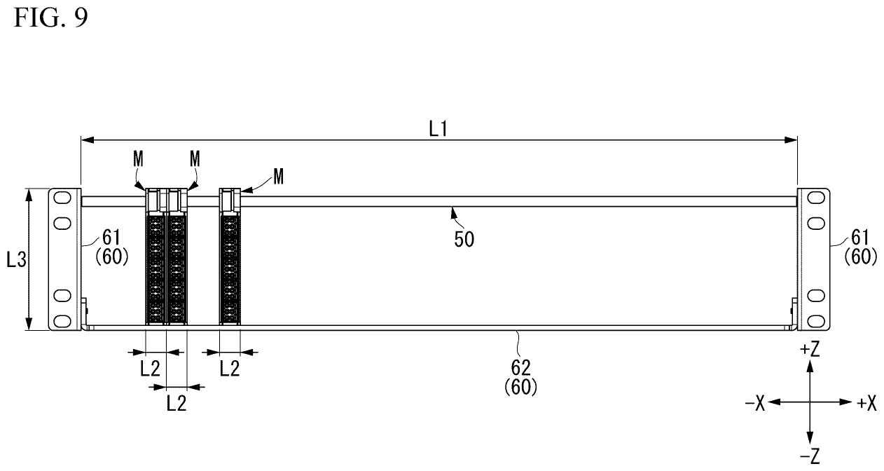

In a case where the restriction member 20A is in the allowance state, the operator can relatively move each adapter module M in the longitudinal direction (second direction X) of the shaft member 50 and access a desired adapter module M, and can insert and remove the optical connector 70 in the adapter module M. In order to facilitate the insertion and removal of the optical connector 70 via the operator, in the optical connection assembly 1 according to one or more embodiments, the distance over which the plurality of adapter modules M are relatively movable in the second direction X is designed to be equal to or greater than the maximum value of a dimension L4 (see FIG. 6) of the insertion hole 11 in the second direction X. In other words, the distance over which the plurality of adapter modules M are relatively movable in the second direction X is designed to be equal to or greater than the dimension of the optical connector 70 in the second direction X. In one or more embodiments, more specifically, when the dimension of the shaft member 50 in the second direction X is denoted as L1 (see FIG. 9), the dimension of each adapter module M in the second direction X is denoted as L2, and the number of the adapter modules M included in the optical connection assembly 1 is denoted as N, the “distance over which the plurality of adapter modules M are relatively movable in the second direction X” is equal to “L1−N×L2.” That is, in one or more embodiments, a relationship L1−N×L2≥L4 is established. The dimension L1 can also be interpreted as the interval between the pair of side plates 61 in the second direction X.

As a result of intensive studies by the inventors of the present application, it was found that, by setting the distance over which the plurality of adapter modules M are relatively movable in the second direction X to 20 mm or more, it is easier for a human finger to enter between the adjacent adapter modules M, and it is easier for the operator to move the adapter module M and insert and remove the optical connector 70. Therefore, it is more preferable that the distance over which the plurality of adapter modules M are relatively movable in the second direction X be 20 mm or more. In other words, it is preferable that a relationship L1−N×L2≥20 [mm] be established.

The value of the dimension L1 is, for example, about 442 mm. The value of the dimension L2 is, for example, about 12.8 mm. The value of the dimension L4 is, for example, in a range of 10 to 12 mm. In addition, a dimension L3 of the frame portion 60 (side plate 61) in the first direction Z is, for example, about 87.5 mm.

As described above, an optical connection assembly 1 according to one or more embodiments is an optical connection assembly 1 into which a plurality of optical connectors 70 are inserted, the optical connection assembly 1 including: a plurality of adapter modules M which include a plurality of holding portions 10, which include an insertion hole 11 into which the optical connector 70 is insertable and in which the inserted optical connector 70 is holdable, and in which the plurality of holding portions 10 are disposed in parallel in a first direction Z intersecting an insertion direction (front-rear direction Y) in which the optical connector 70 is inserted; and a shaft member 50 configured to extend in a second direction X intersecting the first direction Z and the insertion direction and support the plurality of adapter modules M, in which the plurality of adapter modules M are relatively movable along the shaft member 50 in the second direction X, and a distance over which the plurality of adapter modules M are relatively movable in the second direction X is equal to or greater than a dimension L4 of the insertion hole 11 in the second direction X.

With this configuration, the operator can easily access a desired adapter module M and the optical connector 70 inserted into the adapter module M by relatively moving each adapter module M with respect to the shaft member 50 in the second direction X. In addition, when accessing the optical connector 70, it is only necessary to move the adapter module M in the second direction X within the housing 2. Therefore, with the optical connection assembly 1 according to one or more embodiments, the wiring density of the optical fibers 71 in the building (data center or the like) can be increased as compared with the configuration in the related art in which the tray needs to be drawn out to access the optical connector (for example, see Patent Document 1).

In addition, in the above-described configuration in the related art, when the tray is drawn out from the housing or inserted into the housing, excessive bending may be applied to the optical fiber inside the tray, causing damage to the optical fiber. On the other hand, in the optical connection assembly 1 according to one or more embodiments, it is only necessary to move the adapter module M in the second direction X when accessing the optical connector 70. Therefore, excessive bending is less likely to be applied to the optical fiber 71, and the possibility of damage to the optical fiber 71 can be reduced.

In addition, the first direction Z is a gravity direction, and the shaft member 50 supports the upper end portion of the adapter module M. With this configuration, the second direction X, which is the direction in which the adapter module M moves, is not parallel to the gravity direction. As a result, the influence of gravity on the movement of the adapter module M is reduced, making it easier for the operator to operate the adapter module M.

In addition, the adapter module M includes a restriction member 20A. The restriction member 20A is switchable between a restriction state in which the relative movement of the adapter module M with respect to the shaft member 50 is restricted and an allowance state in which the relative movement of the adapter module M with respect to the shaft member 50 is allowed by moving in the insertion direction (front-rear direction Y). With this configuration, workability of the insertion and removal work of the optical connector 70 can be improved. More specifically, for example, the insertion and removal of the optical connector 70 with respect to the adapter module M can be facilitated by fixing the adapter module M to the shaft member 50 using the restriction member 20A.

In addition, the restriction member 20A has an inserting hole 23 through which the shaft member 50 is inserted and which is elastically expandable and contractible, the inserting hole 23 includes a small diameter portion 23a in which a first virtual circle C1 is inscribed when viewed from the second direction X and a large diameter portion 23b in which a second virtual circle C2 is inscribed when viewed from the second direction X and which communicates with the small diameter portion 23a in the front-rear direction Y, and in a case in which a diameter of the first virtual circle C1 is denoted as Φ1, a diameter of the second virtual circle C2 is denoted as Φ2, and a diameter of the shaft member 50 is denoted as Φ3, a relationship Φ1<Φ3<Φ2 is established. With this configuration, it is possible to easily realize the restriction member 20A which can be switched between the restriction state and the allowance state.

In addition, a maximum value of the dimension L4 of the insertion hole 11 in the second direction X may be in a range of 10 to 12 mm. In other words, the dimension of the optical connector 70 to be inserted into the insertion hole 11 in the second direction X may be in the range of 10 to 12 mm. With this configuration, the wiring density of the optical fibers 71 can be increased.

In addition, the distance over which the adapter module M is relatively movable in the second direction X may be 20 mm or more. With this configuration, it is easier for a human finger to enter between the adjacent adapter modules M, and it is easier for the operator to move the adapter module M and insert and remove the optical connector 70.

Next, one or more embodiments will be described, but basic configurations thereof are the same as the above-described embodiments.

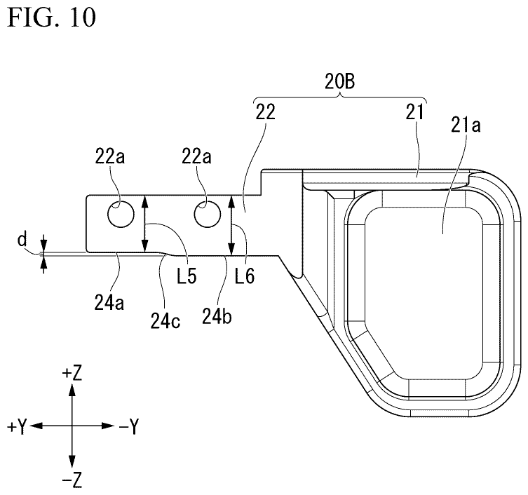

Therefore, the same configurations will be denoted by the same reference numerals, descriptions thereof will be omitted, and only different points will be described. In one or more embodiments, as shown in FIG. 10, the shape of a restriction member 20B is different from the shape of the restriction member 20A in the above-described embodiments.

The restriction portion 22 according to one or more embodiments does not have the inserting hole 23 through which the shaft member 50 is inserted. The lower surface of the restriction portion 22 according to one or more embodiments includes a first extending surface 24a, a second extending surface 24b, and an inclined surface 24c. The first extending surface 24a is a surface that extends parallel to the front-rear direction Y from the rear end (+Y end) of the restriction portion 22 toward the front (−Y side). The second extending surface 24b is a surface that extends parallel to the front-rear direction Y from the front end (−Y end) of the restriction portion 22 toward the rear (+Y side). The second extending surface 24b is positioned below the first extending surface 24a by a dimension d. That is, a dimension L5 of the restriction portion 22 on the first extending surface 24a along the first direction Z is smaller than a dimension L6 of the restriction portion 22 on the second extending surface 24b along the first direction Z by the dimension d. The inclined surface 24c is a surface that connects the front end (−Y end) of the first extending surface 24a and the rear end (+Y end) of the second extending surface 24b. In addition, two pin holes 22a are formed in the restriction portion 22 according to one or more embodiments. One pin P is inserted into each of the two pin holes 22a.

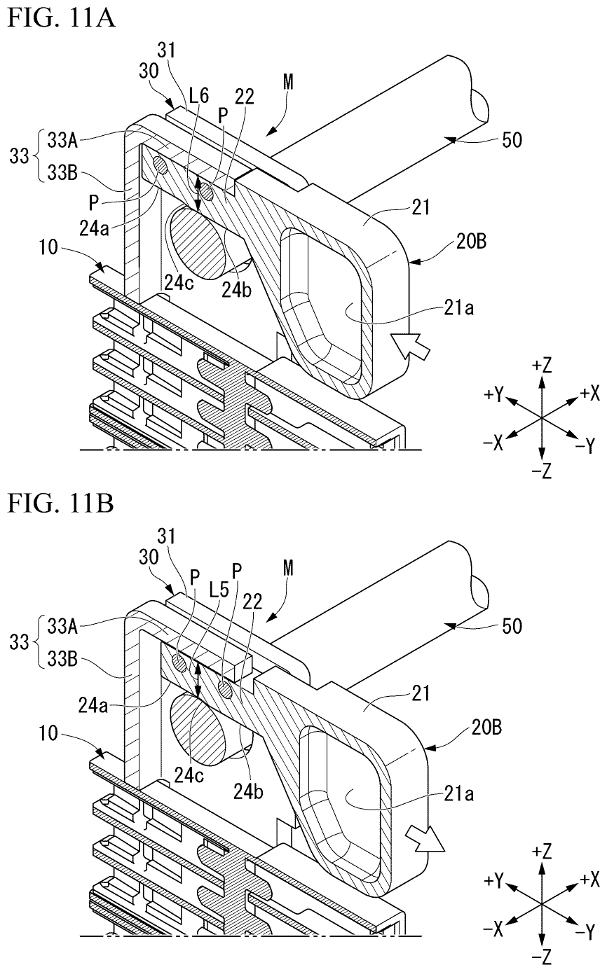

As shown in FIGS. 11A and 11B, the restriction portion 22 according to one or more embodiments is inserted between the shaft member 50 and the first portion 33A of the connection portion 33 in the first direction Z. In the state shown in FIG. 11A, where the restriction portion 22 is inserted deep into the base member 30 and the second extending surface 24b comes into contact with the shaft member 50, the restriction portion 22 presses the shaft member 50 downward, and a frictional force acts between the restriction portion 22 and the shaft member 50. As a result, the restriction member 20B is in the restriction state where the relative movement of the adapter module M with respect to the shaft member 50 in the second direction X is restricted. Meanwhile, in the state shown in FIG. 11B, where the restriction member 20B is drawn out to the front and the first extending surface 24a comes into contact with the shaft member 50, the restriction portion 22 does not press the shaft member 50. That is, the restriction member 20B is in the allowance state where the relative movement of the adapter module M with respect to the shaft member 50 in the second direction X is allowed. As described above, the restriction member 20B according to one or more embodiments is also configured to be switched between the restriction state and the allowance state by moving in the front-rear direction Y, similarly to the restriction member 20A according to the above-described embodiments. In one or more embodiments, the pin P and the elongated hole 31a (see also FIG. 4) also play a role in preventing the restriction member 20B from falling from the base member 30.

Note that, the technical scope of the present invention is not limited to the above-described embodiments, and various modifications can be made without departing from the spirit of the present invention.

For example, the first direction Z need not substantially match the gravity direction. For example, the second direction X may substantially match the gravity direction. In addition, the first direction Z in which the plurality of holding portions 10 are arranged and the second direction X in which the shaft member 50 extends need only intersect each other, and do not necessarily have to be orthogonal to each other. Similarly, the front-rear direction Y and the first direction Z need only intersect each other and do not necessarily have to be orthogonal to each other. The front-rear direction Y and the second direction X need only intersect each other and do not necessarily have to be orthogonal to each other.

In addition, the shape of the cabinet 100 shown in FIG. 1 is merely an example and can be changed as appropriate. The configuration of the frame portion 60 may be changed as appropriate depending on the shape of the cabinet 100. The shaft member 50 may be directly fixed to the cabinet 100. In this case, the optical connection assembly 1 need not include the frame portion 60.

In addition, in one or more embodiments, the shaft member 50 supports the upper end portion of the adapter module M, but the shaft member 50 may support the central portion or the lower end portion of the adapter module M. Alternatively, the optical connection assembly 1 may include a plurality of the shaft members 50, and each adapter module M may be supported by the plurality shaft members 50. However, the configuration in which one shaft member 50 supports the upper end portion of the adapter module M, as in one or more embodiments, is suitable because the configuration minimizes the frictional force acting between the shaft member 50 and the adapter module M, making it easier for the operator to move the adapter module M.

In addition, the restriction members 20A and 20B and the spacer 40 may be integrally formed. Alternatively, the adapter module M need not include the spacer 40.

In addition, the configurations of the restriction members 20A and 20B described in one or more embodiments are merely examples, and the configurations can be changed as appropriate as long as the restriction members are configured to be switched between the restriction state and the allowance state. Alternatively, the optical connection assembly 1 need not include the restriction members 20A and 20B.

In addition, the number of holding portions 10 included in each adapter module M, the number of optical connectors 70 and optical fibers 71 inserted into each holding portion 10, and the number of optical fibers 71 inserted into each adapter module M can be changed as appropriate. For example, the number of optical fibers 71 that can be inserted into one adapter module M from the front (one direction) may be twenty-nine or less, or thirty-one or more.

In addition, the number N of the adapter modules M included in the optical connection assembly 1 is not limited to three. In a case where the above-described condition “L1−N×L2>L4” is established, N can be a value of any natural number. N is, for example, twenty-nine.

In addition, it is possible to appropriately replace the constituent elements in the above-described embodiments with well-known constituent elements and the above-described embodiments and modification examples may be appropriately combined without departing from the spirit of the present invention.

### REFERENCE SIGNS LIST

1: Optical connection assembly
M: Adapter module
10: Holding portion
11: Insertion hole
20A, 20B: Restriction member
23: Inserting hole
23a: Small diameter portion
23b: Large diameter portion
50: Shaft member
70: Optical connector
71: Optical fiber
Z: First direction
X: Second direction
Y: Front-rear direction

1. An optical connection assembly into which a plurality of optical connectors are inserted, the optical connection assembly comprising:
adapter modules that each comprise holding portions that each have an insertion hole into which the optical connector is insertable,
wherein
the holding portions are disposed in parallel in a first direction intersecting an insertion direction in which the optical connector is inserted; and
a shaft member that:
extends in a second direction intersecting the first direction and the insertion direction; and
supports the plurality of adapter modules, wherein
the adapter modules are relatively movable along the shaft member in the second direction, and
a distance over which the plurality of adapter modules are relatively movable is equal to or greater than a dimension of the insertion hole in the second direction.

2. The optical connection assembly according to claim 1, wherein
the first direction is a gravity direction, and
the shaft member supports an upper end portion of the adapter module.

3. The optical connection assembly according to claim 1, wherein
the adapter module includes a restriction member, and
the restriction member is switchable between:
a restriction state in which a relative movement of the adapter module with respect to the shaft member is restricted; and
an allowance state in which the relative movement of the adapter module with respect to the shaft member is allowed by moving in the insertion direction.

4. The optical connection assembly according to claim 3, wherein
the restriction member has an inserting hole through which the shaft member is inserted and which is elastically expandable and contractible,
the inserting hole includes:
a first diameter portion in which a first virtual circle is inscribed when viewed from the second direction; and
a second diameter portion in which a second virtual circle is inscribed when viewed from the second direction and which communicates with the smaller diameter portion in the insertion direction, and
a relationship Φ1<Φ3 <Φ2 is established, where
Φ1 is a diameter of the first virtual circle,
Φ2 is a diameter of the second virtual circle, and
Φ3 is a diameter of the shaft member.

5. The optical connection assembly according to claim 1, wherein
a number of optical fibers that are insertable from one direction per adapter module is thirty or more.

6. The optical connection assembly according to claim 1, wherein
a maximum value of the dimension of the insertion hole in the second direction is in a range of 10 to 12 mm, inclusive.

7. The optical connection assembly according to claim 1, wherein
the distance over which the adapter module is relatively movable in the second direction is 20 mm or more.
